(19) United States
(12) Patent Application Publication
(10) Pub. No.: US 2018/0118227 A1
(43) Pub. Date: May 3, 2018

(54) DRIVE FOR A TRACK-GUIDED VEHICLE

(71) Applicants: Benedikt CLAAS, Northeim (DE); Dix Claas, Magstadt (DE)

(72) Inventors: Benedikt CLAAS, Northeim (DE); Dix Claas, Magstadt (DE)

(21) Appl. No.: 15/854,193

(22) Filed: Dec. 26, 2017

Related U.S. Application Data
(63) Continuation of application No. PCT/EP2015/064119, filed on Jun. 23, 2015.

(51) Int. Cl. B61B 13/04; B60L 13/00; B61B 13/08; B61C 11/06; E01B 25/08

(52) U.S. Cl. CPC B61B 13/04; B60L 13/006; B60L 2200/26; B61C 11/06; E01B 25/08; B61B 13/08

(57) ABSTRACT

A drive for a vehicle which is track-guided on a track section, the vehicle being supported on the track section by track rollers when at a standstill or when moving slowly. Lift-causing elements are mounted on the vehicle and lift the vehicle off the track section during fast travel, and drive rollers of the vehicle act laterally on the track section.

This nonprovisional application is a continuation of International Application No. PCT/EP2015/064119, which was filed on Jun. 23, 2015, and which is herein incorporated by reference.

### BACKGROUND OF THE INVENTION

### Field of the Invention

The invention relates to a drive for a vehicle which is track-guided on a track section, the vehicle being supported on the track section by track rollers when at a standstill and when traveling slowly.

### Description of the Background Art

The movement of track-guided vehicles, such as railroad cars, is opposed by different forces. These include the frictional forces of a wheel/rail system. To deliver the driving forces to the rail via non-positive friction, the vehicles must be heavy. It has therefore long been a desire to provide a modified drive without power transmission via non-positive friction. This has led to the development of the magnetic levitation train, in which the railroad cars float over the track section contact-free and are driven by a linear motor. The technology of the magnetic levitation train is very energy-consuming since large electromagnets constantly have to be energized. Also, production of the track section is very expensive.

From the automotive industry it is known to optimize the aerodynamic properties of a vehicle in order to save driving power. To this end, spoilers and similar components are used.

### SUMMARY OF THE INVENTION

It is therefore an object of the invention to provide a drive for a track-guided vehicle, in which the energy required, as compared to conventional vehicles, is significantly reduced and thus allows for easier construction of the vehicle and a single track section.

A drive for a track-guided vehicle, in particular a railroad car, is proposed, which is guided on a track section. The vehicle is supported on the track section by track rollers when at a standstill and when traveling slowly.

The vehicle is characterized in that attached thereto are buoyancy elements that raise the vehicle above the track section during fast travel, and drive rollers of the vehicle act laterally on the track section.

By means of the buoyancy elements, the vehicle experiences an upward force that raises it a bit above the track section. This way, the driving force required for the propulsion of the vehicle is significantly reduced.

The vehicle is guided on the track section by the drive wheels acting laterally on the track section. These act both when traveling slowly, when the vehicle is supported by the track rollers, as well as in the raised position.

The track section is designed such that it can have at least one rail.

In an embodiment, a single rail itself may be the track section and the drive wheels are pressed against it by means of actuating cylinders. If the drive wheels are in duplicate on each side of the track section, the necessary force can be applied for lateral stabilization.

Guidance of the vehicle on the rail is further improved when even in the raised state, the track roller is pressed against the rail with a spring.

In an embodiment, the track section is an upright track of rectangular cross section, on which two parallel rails are provided. On the rails, the vehicle is supported by track rollers when at a standstill and or when traveling slowly.

In an embodiment, the driving force can be applied via drive wheels that act laterally on the track section.

During fast travel, the buoyancy force can be applied via buoyancy elements, such as wings, that are connected to the housing of the vehicle. These can be firmly attached to the housing of the vehicle, such as to the roof. However, wings that are extended only when the vehicle travels fast are also possible.

Another possibility is that air conduits are incorporated in the housing of the vehicle, in which the buoyancy elements are positioned.

In order to reduce the frictional forces of the vehicle, only a small lifting of the housing from the rail is required. However, for the drive wheels not to lose contact with the track section due to excess lifting, a height limitation is provided at the track section by means of limiting profiles.

The housing of the vehicle advantageously clasps around a part of the track section. To this end, a tunnel is provided in the bottom of the housing, which is so wide that even a track section that is flexed for curves can fit.

The drive proposed herein is also suitable for an articulated train, in which in each case adjacent housings of railroad cars rest on a common chassis. On the chassis, the clutches of the adjacent cars are attached, which must also ensure the lateral stability of the housing.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic cross section through a vehicle with a drive;

FIG. 2 is a schematic view of a vehicle on a track section;

FIG. 3 is a view of the vehicle from below with the tunnel for the track section;

FIG. 4 is a detail of the drive;

FIG. 5 is a drive with guide bracket;

FIG. 6 is a schematic cross section through a vehicle on a track section having two rails; and

FIG. 7 is a schematic view of an articulated train on a track section.

### DETAILED DESCRIPTION

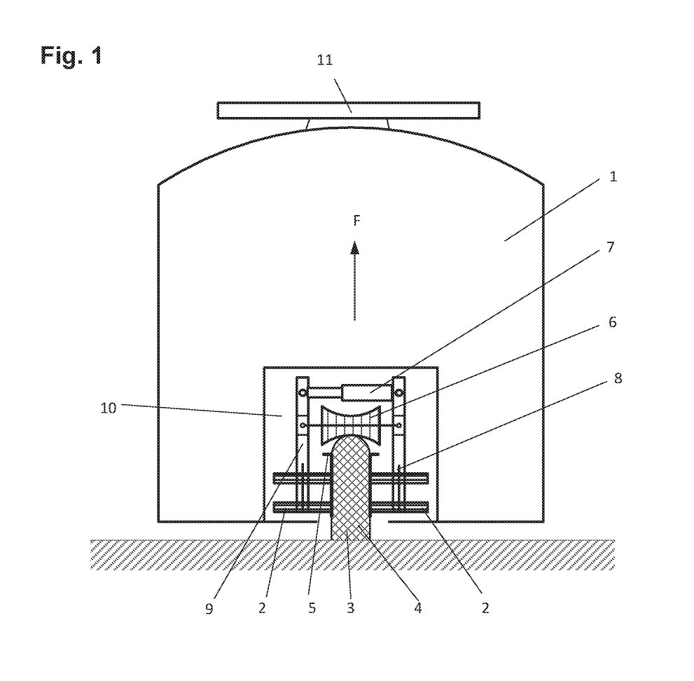

FIG. 1 shows a schematic cross section through a vehicle with its drive. The track section 3 and the drive wheels 2 are located in the tunnel 10 in the bottom of the housing 1.

At a standstill of the track roller 6, the housing 1 is held on the track section 3 which is formed in this embodiment as a rail 4. On top of the housing, the buoyancy elements 11 are mounted which generate the buoyancy force F during fast travel. With a sufficiently high buoyancy force F, the housing 1 lifts up from the rail 4 by its track roller 6.

On both sides of the track section 3, the drive wheels 2 press on the limiting profile 5, which prevent a higher lifting upwards of the housing 1 and thus of the drive wheels 2. The pressure of the drive wheels 2 is provided by the actuating cylinder 7, said wheels delivering their pressing force via the push rods 9 and the wheel axles 8 against the drive wheels 2.

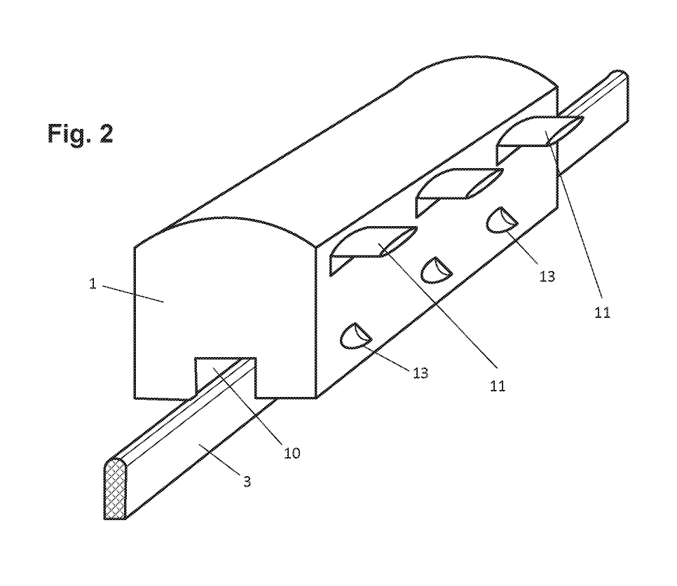

FIG. 2 shows a schematic view of a vehicle with its housing 1 on a track section 3. The track section 3 passes through the tunnel 10 of the housing 1. Laterally, buoyancy elements 11 extend from the housing 1. Furthermore, air inlets 13 are provided, through which air flows within air conduits of the housing 1 with buoyancy elements.

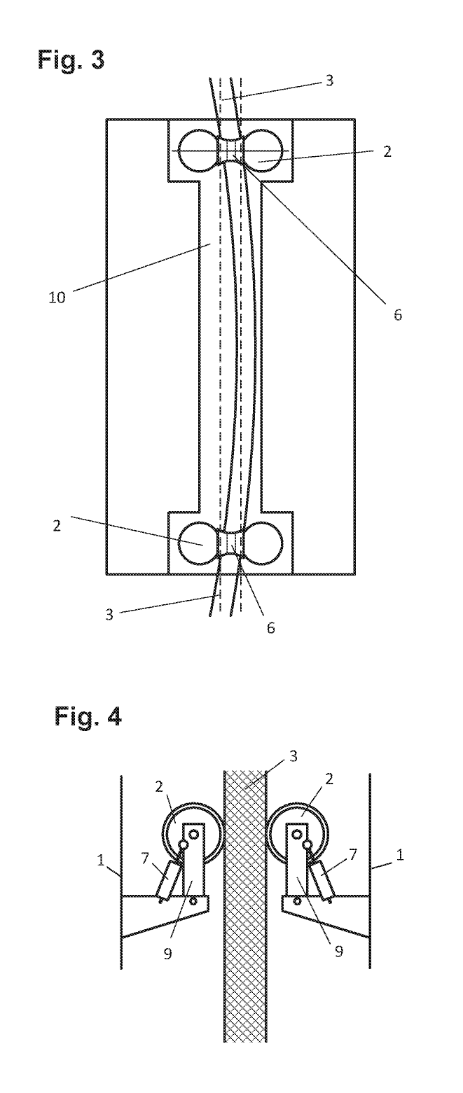

FIG. 3 shows a bottom view of the vehicle with its tunnel 10, through which the track section 3 extends. The tunnel 10 is kept wide enough for a curved track section to have sufficient space. The vehicle is driven by the drive wheels 2, which are laterally pressed against the track section 3. The track rollers 6 are positioned over the track section 3 for support.

FIG. 4 shows a detail of an embodiment of the drive. The drive wheels 2 are pressed against the track section 3 via the actuating cylinders 7. They are held by the push rods 9, which are hingedly connected to the housing 1.

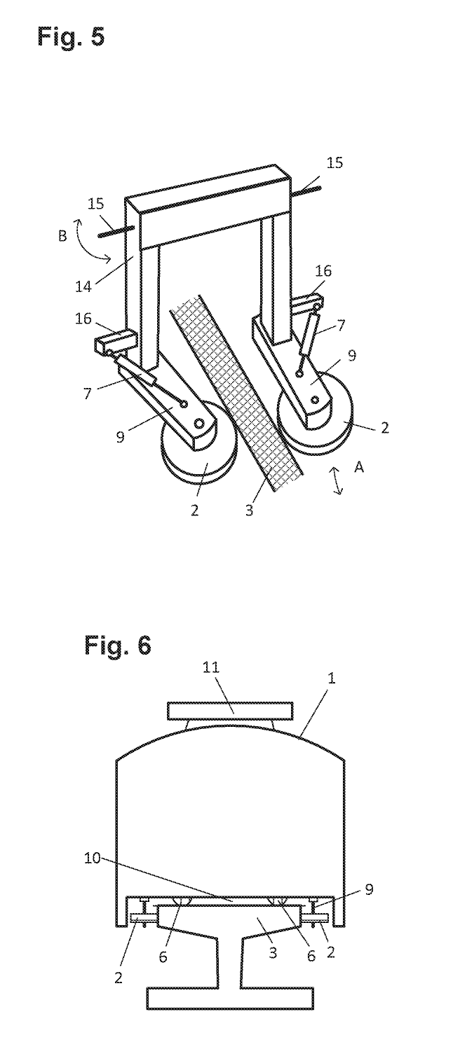

FIG. 5 shows an embodiment of the drive having a guide bracket 14. The guide bracket 14 is mounted via the pivot rods 15 on the vehicle and thus can execute a limited pivoting movement B. In this way, the drive wheels 2 pressed against the track section 3 can also bring about an upward or downward movement A.

The driving force of the vehicle on the track section 3 is applied via the drive wheels 2, which are pressed against the track section 3 via the pressure cylinders between the pressure rods 9 and the counter supports 16.

FIG. 6 shows a schematic cross section through a vehicle on a wide track section 3 having two rails 4, which are guided in parallel. The two track rollers 6 are in the tunnel 10 of the housing 1, with which the housing 1 can be supported on the rails 4. The drive wheels 2 are laterally pressed against the track section 3 via the push rods 9.

The buoyancy elements 11 are mounted on the roof of the housing 1.

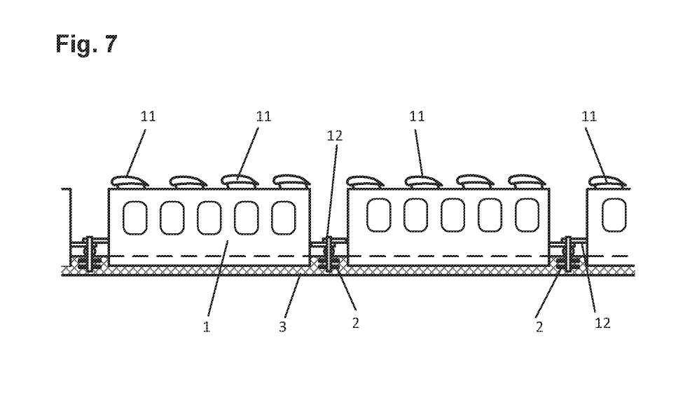

FIG. 7 shows a schematic view of an articulated train on a track section 3. In this case, the by couplings 12 of the housing 1 of adjacent railroad cars are supported on a common chassis, which contains the drive wheels 2.

The buoyancy elements 11 are fixed on the roofs of the housing 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drive for a vehicle which is track-guided on a track section, which at a standstill and when traveling slowly is supported by track rollers on the track section, the drive comprising:
buoyancy elements mounted on the vehicle that lift the vehicle above the track section during fast travel; and
drive rollers that laterally act on the track section.

2. The drive according to claim 1, wherein the track section comprises at least one rail.

3. The drive according to claim 2, wherein, in a raised position, the track roller is further pressed against an associated rail.

4. The drive according to claim 1, wherein the track section is an upright track section having a rectangular cross section.

5. The drive according to claim 1, wherein the buoyancy elements are wings that are connected to the housing of the vehicle.

6. The drive according to claim 5, wherein the wings are extendable.

7. The drive according to claim 5, wherein the wings are mounted in air conduits of the housing.

8. The drive according to claim 1, wherein the drive wheels are pressed against the track section by a pressure cylinder.

9. The drive according to claim 8, wherein, on each side of the track section, the drive wheels are in duplicate, positioned one above the other.

10. The drive according to claim 1, wherein limiting profiles are mounted on the track section that limit upward movement of the vehicle.

11. The drive according to claim 1, wherein the drive wheels are mounted in a lower tunnel of the housing through which the track section runs.

12. The drive according to claim 1, wherein the drive wheels are mounted on a chassis on which the adjacent housings of the railroad cars of an articulate train are supported.
